(19) United States
(12) Patent Application Publication
(10) Pub. No.: US 2009/0063185 A1
(43) Pub. Date: Mar. 5, 2009

(54) SYSTEM FOR INTEGRATING AND MANAGING HEALTH RELATED INFORMATION

(75) Inventors: Chin-Hsiung Chang, Tai-Chung (TW); Fu-Chung Yen, Plano, TX (US)

Correspondence Address: AKIN GUMP STRAUSS HAUER & FELD, LLP, P O BOX 688, DALLAS, TX, 75313-0688, US

(73) Assignee: FEGO Precision Industrial Co., Ltd., Tai-Chung (TW)

(21) Appl. No.: 11/847,842

(22) Filed: Aug. 30, 2007

(51) Int. Cl. G06Q 50/00

(52) U.S. Cl. 705/2

(57) ABSTRACT

A system for integrating and managing health related information. The system comprises at least one portable data storage device, adapted to store data comprising health related information; at least one external device, adapted to provide health related information; and at least one component adapted to manipulate the health related information stored in the at least one portable data storage device. The at least one external device and the at least one component are adapted to exchange data with the at least one portable data storage device, when the at least one portable data storage device is removably connected with the at least one external device or the at least one component. The health related information in the at least one portable data storage device is stored in a specific format, and is accessible by any external device or component in the system.

### CROSS-REFERENCE TO RELATED APPLICATIONS

This application is related to: U.S. application Ser. No. unknown, filed currently with the present application on Aug. 30, 2007, entitled “BLOOD PRESSURE MEASUREMENT DEVICE”, by Chin-Hsiung Chang and Fu-Chung Yen; and U.S. application Ser. No. unknown, filed currently with the present application on Aug. 30, 2007, entitled “SYSTEM FOR PROVIDING NOTES IN MEASUREMENT DEVICES”, by Chin-Hsiung Chang and Fu-Chung Yen.

### TECHNICAL FIELD OF THE INVENTION

The present invention relates generally to healthcare and physical wellbeing, and more particularly, to a system for integrating and managing health related information.

### BACKGROUND OF THE INVENTION

Health awareness is becoming increasingly popular around the world. People tended to use more health related services and devices, such as going to gyms more frequently, receiving personal healthcare instructions, and utilizing more healthcare devices, etc., and to make more use of the health related information provided with the services or the devices, for tracking, monitoring or improving their physical wellbeing. The health related information may include various data that are useful and related to healthcare and physical wellbeing, such as blood pressure, heart rate, body fat and body weight of a person, an electrocardiogram (ECG or EKG), a prescription, a rehabilitation schedule, a fitness plan, a fitness training program, an exercise record, or a diet plan, etc.

The health related information provides an overview regarding certain aspects of health conditions, and helps guide to take corresponding actions. The health related information is very useful to people in various fields. For instance, blood pressure measured over time may be used to monitor blood pressure of an ordinary user, or to determine whether an anti-hypertensive drug is effectively managed as desired by a doctor, or to determine how and what exercises help keep normal blood pressure by a fitness trainer. Fitness information may help guide a user to control the body fat and body weight, or help a fitness trainer design various training programs for trainees. The health related information is of growing significance and may even be used daily for healthcare purposes.

Health related data obtained from various devices or services may be correlated and used. For example, medical information obtained after visiting a doctor may be a very useful reference for a nutritionist; exercise timetable may be designed, together with medications taken, to control high blood pressure; and blood pressure measurement may further provide feedback to the timetable design and medication adjustment. Combination of various health related data may provide a comprehensive and meaningful picture of health conditions, and work as one of the sources regarding health that may be used by doctors, nutritionists, fitness trainers, healthcare advisors, lifestyle advisors, healthcare device end users, and fitness equipment users, etc. Therefore, it is important and useful to collect and store accurate health related data from various devices or services, and to provide flexibility to exchange and integrate the data, and analyze the data comprehensively.

Benefited from the modern information technology, most of current services or devices provide the ability to electronically capture and/or store the health related information. For example, a blood pressure meter measures blood pressure of a user, and saves the measurement in an embedded memory in the blood pressure meter; a fitness machine or apparatus, such as a treadmill, may display exercise related parameters, such as speed, heart rate, and calories consumed, as a user is performing the exercises. These electronically captured or stored data greatly facilitate storage and use of the health related information.

Various devices in the market are designed to measure and store health related data independently, such as devices for measuring blood pressure, weight, body fat, blood cholesterol, and heart rate, etc. Some devices are configured to measure two or more health related parameters, e.g., a blood pressure meter may measure both blood pressure and heart rate. However, data stored in these devices generally can not be flexibly transferred to or used by other devices. Furthermore, though each of the devices may provide one aspect of useful health related data, there is no mechanism to support systematical storage, exchange, and manipulation of the various health related data, which, if integrated together, may be used more efficiently and meaningfully; and there is also no mechanism to comprehensively analyze the various integrated health related data.

In addition, some devices, such as a fitness apparatus, may be able to measure and display exercise related information. However, these devices generally do not support output of the displayed information. The fitness apparatus may not store the displayed information after the exercise is performed.

Moreover, health related data provided by some devices may also be incorrect or inaccurate. For instance, certain fitness apparatus or machines may ask a user to input personal information—such as age or weight—before starting exercises, and then calculate exercise effort using the personal information. The exercise effort may vary for different users with different ages, weight, gender, etc. It is not unusual that a user directly uses a fitness apparatus without inputting any personal information. In such a case, the fitness apparatus may utilize pre-stored physical parameters to do the calculation. As a consequent, the result calculated by the fitness apparatus will not reflect real exercise effort of the user. For example, calories consumed when performing certain exercises may be calculated using a value of weight already stored, if no data of weight is input by the user. Thus the user will not get a correct or accurate value of calories consumed. In addition, adverse exercise effect may be caused when a specific training pattern is selected based on the incorrect or inaccurate information.

Therefore, there is a need for a system that flexibly integrates and manages health related information provided by various health related devices or services, providing data exchange between the various health related devices or services, and correlating health related information and improving efficiency of using the health related information.

### SUMMARY OF THE INVENTION

A system for integrating and managing health related information is provided. The system comprises at least one portable data storage device, adapted to store data comprising health related information; at least one external device, adapted to provide health related information; and at least one component adapted to manipulate health related information stored in the at least one portable data storage device. The at least one external device and the at least one component are adapted to exchange data with the at least one portable data storage device, when the at least one portable data storage device is removably connected with the at least one external device or the at least one component. The health related information in the at least one portable data storage device is stored in a specific format, and is accessible by any external device or component in the system.

The following description and drawings set forth in detail a number of illustrative embodiments of the invention. These embodiments are indicative of but a few of the various ways in which the present invention may be utilized.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram depicting an embodiment of a system structure for integrating and managing health related information according to the present invention;

FIG. 2A is a diagram depicting an embodiment of using the system of FIG. 1 according to the present invention;

FIG. 2B is a diagram depicting how the system in FIG. 1 forms a close-loop system according to the present invention;

FIG. 3 is a diagram depicting an embodiment of a functional structure for the system in FIG. 1 according to the present invention;

FIG. 4 is a diagram depicting an embodiment of a main page for a user interface used to manipulate health related information according to the present invention;

FIG. 5 is a diagram depicting an embodiment of a displayed note according to the present invention;

FIG. 6 is a diagram depicting an embodiment for displaying the health related information by graphs according to the present invention;

FIG. 7 is a diagram depicting another embodiment for displaying the health related information by graphs according to the present invention;

FIG. 8 is a diagram depicting an alternative embodiment for displaying the health related information by graphs according to the present invention;

FIG. 9 is a diagram depicting an embodiment of multiple windows displayed on a computer screen according to the present invention;

FIG. 10 is a diagram depicting an embodiment of displaying statistic analysis data according to the present invention; and

FIG. 11 is a diagram depicting an embodiment of an interface to edit a fitness training program according to the present invention.

### DETAILED DESCRIPTION

The following discussion is presented to enable a person skilled in the art to make and use the invention. The general principles described herein may be applied to embodiments and applications other than those detailed below without departing from the spirit and scope of the present invention as defined herein. The present invention is not intended to be limited to the embodiments shown, but is to be accorded the widest scope consistent with the principles and features disclosed herein.

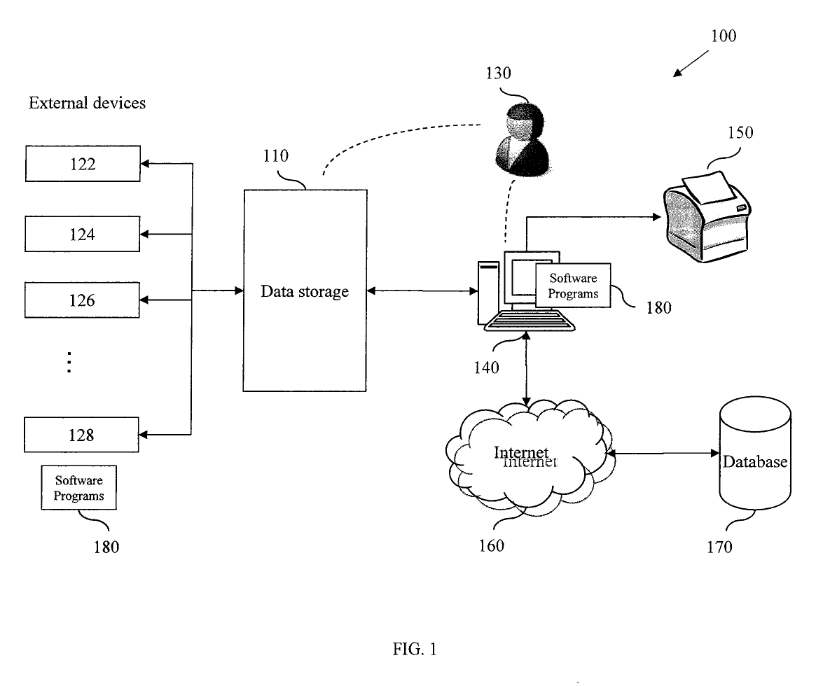

Referring now to FIG. 1, a diagram illustrating a structure of a system (100) for integrating and managing health related information according to one embodiment of the present invention. The health related information may comprise various health related data that may be provided by various health related devices or services, and other related data involved in the system (100), which will be described later.

The system (100) comprises a data storage device (110) for storing data; and a plurality of external devices (122)-(128) that may be located in a variety of places, for providing various health related data and other related data. There may be one or more such external devices in the system (100). The data storage device (110) may be carried by a user (130), and be flexibly and conveniently connected with each of the plurality of external devices (122)-(128), exchanging data with the plurality of external devices (122)-(128). The user (130) may be any person, such as a patient, a doctor, a nutritionist, a fitness trainer, a healthcare device or fitness equipment owner, etc.

The plurality of external devices (122)-(128) may exchange data with, e.g., write to or read from, the data storage device (110) when connected with the data storage device (110). The data storage device (110) may be physically connected, directly or indirectly, with each of the external devices (122)-(128), or in wireless connection with each of the external devices (122)-(128). The data storage device (110) may be connected with one of the external devices (122)-(128) when data exchange is needed, and removed from the external device when the data exchange is finished.

The data storage device (110) maybe connected with a computer (140), physically or wirelessly. The computer (140) may also be taken as one of the external devices (122)-(128), since the computer (140) may provide data, and exchange data with the data storage device (110) too. However, in this embodiment, the computer (140) is described separately from the external devices (122)-(128), for other different functions of the computer (140) may be involved in this embodiment. The user (130) may manipulate—i.e., view, edit, add, delete, backup, output, store, or analyze, etc. -the heath related data and other related data through the computer (140), e.g., store the data in the computer (140), or print out the data to obtain hard copies using a printer (150). The role of the computer (140) may also be played by a Personal Digital Assistant (PDA), the data storage device (110), if the data storage device (110) has microprocessors, such as a CPU, and a display screen, and provides functions the same as the computer (140) in the embodiment; or an equivalent device that may allow a user to manipulated the health related data and other related data.

The computer (140) may be connected to an Internet or a Local Area Network (LAN) (160). The users (130) may further upload the data stored in the data storage device (110) to a database server (170) connected to the Internet or the LAN (160), and retrieve desired data from the database server (170). Thus, data stored in the data storage device (110) may also be accessed through the Internet or the LAN (160).

Each of the external device (122)-(128) or the computer (140) may write to or read from the data storage device (110). Software programs (180) may be provided on the external devices (122)-(128) or the computer (140). One function of the software programs (180) may allow data written to the data storage device (110) to be stored in a specific format, such that data stored may be accessible to each of the external devices (122)-(128), or the computer (140) in the system (100). The format refers to, but not limited to, format of data to be written to the data storage device (110), or file structures by which data is organized in the data storage device (110), etc.

Utilizing the data storage device (110), various health related data and other related data may be integrated together, that is, provided by the plurality of external device (122)-(128) or the computer (140), collected using the data storage device (110), and stored in a specific format.

The system (100) may also provide management of the various health related data and other related data. The term management in the embodiments of the present invention may be accorded a meaning including, but not limited to, managing the integration of the health related data and other related data, managing the integrated data; configuring the external devices (122)-(128) or the computer (140) to provide desired health related data and other related data, and store those data in certain formats; managing data exchange between external devices (122)-(128) or the computer (140) and the data storage device (110); and manipulate the integrated data, such as view, edit, add, delete, backup, output, or analyze the integrated data, etc. The software programs (180) may provide functions to manage the various health relate data and other related data. Analysis results produced may be saved in the database server (170), the computer (140) or the data storage device (110), displayed on the computer (140), and printed out with the printer (150).

Since each of the external devices (122)-(128) and the computer (140) may exchange data with the data storage device (110), and access the data stored in the data storage device (110), the system (100) enables data exchange between any two of the external devices (122)-(128), or between any of the external devices (122)-(128) and the computer (140). This greatly improves efficiency and flexibility of using various health related data and other related data provided by different external devices.

Therefore the data storage device (110), with the data stored therein, may be carried around by the user (130), and connected with any external device, e.g. (122), or the computer (140), as long as the external device or the computer (140) provides a corresponding connection interface. The data storage device (110) may take various forms. For instance, the data storage device (11) may comprise any non-volatile memory products, e.g. flash memory products, or any other applicable portable storage devices. The flash memory products may include, but not limited to, flash drives and flash memory cards, etc.

One example of the data storage device (110) is a Universal Serial Bus (USB) flash drive that may get connected via a USB interface. Because of near-ubiquity of USB support on modern computers and other electronic devices, a USB flash drive may be able to work in many places. An alternative example may be a USB On-The-Go (USB OTG) device, which provides flexibility to be configured either as a host or as a peripheral for data transfer and connection control. The USB OTG device may directly talk to another USB device without requiring services of a computer.

Another example may be a memory stick. When a memory stick is used as the data storage device (110), a memory card reader/writer—which may be a build-in component or a peripheral—may be needed for connecting the memory stick with the computer (140) or the external devices, (122)-(128), reading or writing data. Other examples of the data storage device (110) may include a memory Integrated Circuit (IC) card, or a Radio Frequency Identification (RFID) tag, which may need an IC card reader/writer or a RFID reader/writer, respectively, to exchange data with the external devices (122)-(128), or the computer (140).

The data storage device (110) may also be a portable device that may not only store data but also provide other functions. In one embodiment, the data storage device (110) may be a device having capabilities to both store and manipulate the health related data and other related data. For instance, the data storage device (110) may be a laptop computer, which a user may carry around, and use to store his/her health related information by connecting the laptop computer with different external devices. In this instance, the laptop computer may serve as both the computer (140) and the data storage device (110) in the system (100). Alternatively, the data storage device (110) may comprise a passive memory combined with a PDA.

In other embodiments, in addition to store the health related data and other related data, the data storage device (110) may further provide one or more health related functions. These health related functions may comprise functions that are provided by the external devices (122)-(128) in the system (100), e.g., measuring particular health related data, and/or other functions related to health. For example, the data storage device (110) may be adapted to read an alarm information stored therein, and functions as an alarm maker. The alarm may be made to go off by vibrating or by beeping, etc. Alternatively, the data storage device (110) may be integrated with a room temperature sensor, and the temperature may be measured and stored in the data storage device (110) constantly or periodically. Thus, from this point of view, the data storage device (110) may be both an external device and a storage device to the system (100).

The health related data stored in the data storage device (110) may include various health related records, such as a measurement of body fat, body weight, heart rate, blood pressure, blood cholesterol, blood sugar, etc; a schedule, plan, or records of health related events, e.g., records of performing fitness exercise, or records of medical diagnosis; notes or alarms; personal information about users of the system (100); analysis results of the health related data; or other data provided by any of the external devices (122)-(128), etc. These type of health related data may be provided by the various external devices (122)-(128) or the computer (140), and stored in the data storage device (110).

The health related data may further include health related programs, such as a fitness training program for a fitness apparatus, a medical treatment program for a medical device, or other programs specified for a corresponding eternal device, etc. These programs may be some programs provided, e.g., edited, modified or upgraded, by a user of the system (100) or a professional in a health related field, according to the health related records, trying to improve or sustain health conditions of the user. Functions of the software programs (180) may provide the user and the professional with different level of rights to edit or modify the health related programs. The health related programs may be edited from the computer (140), stored in the data storage device (110), read by the external devices (122)-(128), and run on the external devices (122)-(128), such that a user may receive services from the external devices (122)-(128) as the health related programs instruct. The external devices (122)-(128) may also store health related programs used by the external devices (122)-(128) to the data storage device (110) as records.

Other related data stored in the data storage device (110) may include, but not limited to, system related information, such as software programs to be run on any of the external devices (122)-(128), or the computer (140), configuration information to configure the external devices (122)-(128) or the computer (140), e.g., configuration for defining formats of health related data provided by a blood pressure meter, or any other applicable information.

In this embodiment and in the following descriptions of the present invention, the data storage device will be referred as a Data Storage and Program Provision (DSPP) module, which refers to a portable data storage device storing health related records, programs and/or system related information. However, it is apparent to a person of ordinary skills in the art that a data storage device in the embodiments of the present invention, e.g. (110), may be used to store and transfer any or combination of any type of data. The DSPP module may be any applicable data storage device. The name “DSPP module” used in the present invention should not be construed as a limiting term.

The external devices (122)-(128) may be any electronic device or apparatus that may get connected with the DSPP module (110), communicating with the DSPP module (110), and/or exchanging data with the DSPP module (110). Such an external device may include, but not limited to, a healthcare device, a medical diagnostic or treatment device, a fitness apparatus, a home environment control/monitor device, another data storage device which is not limited to the DSPP module (110), another computer, or any other health related measurement devices. Examples of an external device may include a blood pressure meter, a body weight scale, a body fat analyzer, a treadmill, a stepper, a room temperature reader, or a USB flash drive, etc.

To be connected with the DSPP module (110), an external device, e.g. (122), should have or provide a wire or wireless interface that may get it connected with the DSPP module (110). For example, in the case of a USB flash drive as a DSPP module (110), the external device may need to have a built-in USB port or provide a USB hub; in the case of a memory stick, the external device may need to have a connector, such as a card reader, such that the external device may get connected with the memory stick via the connector. The external device may work as a host that initiates and controls data transfer between the external device and the DSPP module (110), or may work as a peripheral if the DSPP module (110) is a device that can initiate and control data transfer, such as a USB OTG device.

An external device, e.g., (122), may also be a computer in an external facility providing health related services, such as a hospital, and data, such as prescriptions or examination results, may be stored in the DSPP module (110) that is connected with the computer. A patient may carry the DSPP module (110) with him, and use the data stored in the DSPP module (110) for future treatment or diagnosis.

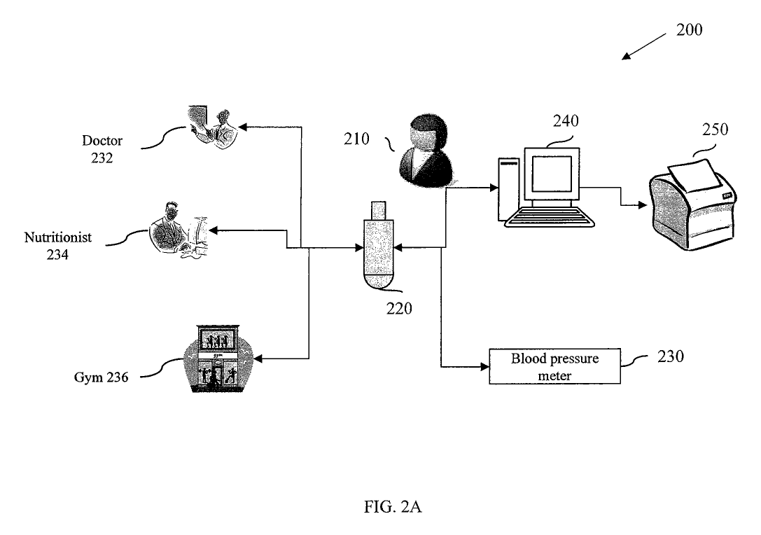

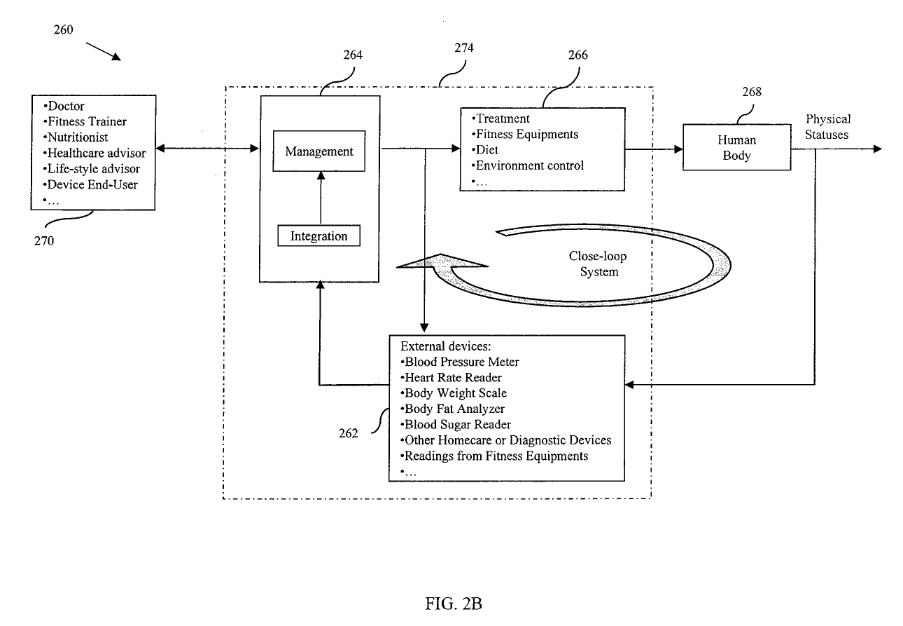

FIG. 2A a diagram (200) illustrating an embodiment for using the system (100). The system (100) in this embodiment includes a USB flash drive (220) as a DSPP module, a blood pressure meter (230), a computer used by a doctor (232), a computer used by a nutritionist (234), and a computer and a plurality of fitness apparatus in a gym (236) as a plurality of external devices. A user (210) may periodically measure his/her blood pressure at home using a blood pressure meter (230), and store each measurement in a predefined format in the USB flash drive (220) by inserting the USB flash drive (220) into a USB port provided by the blood pressure meter (230).

The user (210) may schedule a visit to see the doctor (232) for blood pressure control, carrying the USB flash drive (220) with him. The user (210) may show the blood pressure records measured and stored in the USB flash drive (220) to the doctor (232) as supplemental information. The doctor (232) may read, and/or download the blood pressure data from the USB flash drive (220) as a patient record for the user (210) in a computer, perform examinations to the user (210), prescribe medications and/or make notes in the computer, and store the prescription and/or notes into the USB flash drive (220) when connecting the USB flash drive (220) with the computer.

The user (210) may want to further control his blood pressure by way of nutrition adjustment and exercises. So the user (210) may consult the nutritionist (234) or a fitness trainer in the gym (236), respectively, and also bring the USB flash drive (220) with him. The nutritionist (234), or the fitness trainer in the gym (236), may use the examination results and/or the blood pressure records stored in USB flash drive (220) as references, and provide corresponding suggestions, such as a nutrition plan, an exercise schedule, or fitness training programs. The nutrition plan, exercise schedule, or fitness training programs may also be stored in the USB flash drive (220) as records through the computer in the gym (236). The user (210) may perform exercises using a fitness apparatus in the gym (236) according to the fitness training programs provided and stored in the USB flash drive (220), and store corresponding fitness efforts in the USB flash drive (220).

The user (210) thus has various data concerning his health conditions-blood pressure in this embodiment—obtained from various devices (e.g., the blood pressure meter) and services (e.g., the doctor, nutritionist, and gym) stored in the USB flash drive (220), and may bring the USB flash drive (220) with him wherever he goes, and store or exchange data in USB flash drive (220) whenever he needs. Therefore, health related data provided by one external device is able to be exchanged with the other via the USB flash drive (220). The user (210) may manipulate the data stored in the USB flash drive (220) via his/her computer (240), e.g., archive the data in an Internet database, print out the data by a printer (250), or analyze the data and get a comprehensive results of his blood pressure control.

Consequently, the user (210) may take medications as prescribed, follow the nutrition plan, perform exercises according to the fitness training program, and keep tracking his/her blood pressure level. The user (210) may repeatedly go to the doctor (232), nutritionist (234) or the gym (236) for corresponding examinations or adjustment concerning his/her blood pressure control, using the DSPP module (220) as a convenient source of his health related information.

The system (100) works in the embodiments of the present invention forms a “close-loop” system, as illustrated by a block diagram (260) in FIG. 2B. External devices in (262), such as blood pressure meters, heart rate readers, body weight scales, body fat analyzers, blood sugar readers, other homecare and diagnostic devices, or fitness equipments providing readings, etc, provide various health related data by measuring or reading from human bodies in (268). The various health related data may be integrated and managed in (264), and used by any user in (270), such as doctors, fitness trainers, nutritionists, healthcare advisors, life-style advisors, external device end users, etc.

The integrated and managed data from (264) may be directly fed back to (262), i.e., one external device may make use of the health related data provided by the other; or may result in various health related programs, plans, or device configurations in (266), such as a medical treatment program or plan, fitness training programs, diet plan or schedule, or environment control configurations, etc, which may be applied on human bodies in (268). These health related programs, plans, or configurations may help maintain or improve body health, which may be monitored through the measurements of external devices in (262). Thus, a close-loop system is formed which correlates different health related devices and services, and hence, health related information provided thereby, such that each health related devices and services may benefit from the others in maintaining and improving body health conditions.

Referring to the system (100) in FIG. 1 again, software programs may be provided on the external devices (122)-(128) or the computer (140), respectively, for integrating and managing the health related data and other related data of the system (100). In the following descriptions, “firmware” is used to refer to software programs installed or running on the external devices (122)-(128), and “software” is used to refer to programs running on the computer (140). The software may also be stored in the DSPP module (110) and run from the DSPP module (110) when the DSPP module (110) is connected with the computer (140). The use of “firmware” and “software” is just for description convenience, and is not to be construed as limiting. The system (100) will be referred to throughout the following descriptions for description convenience.

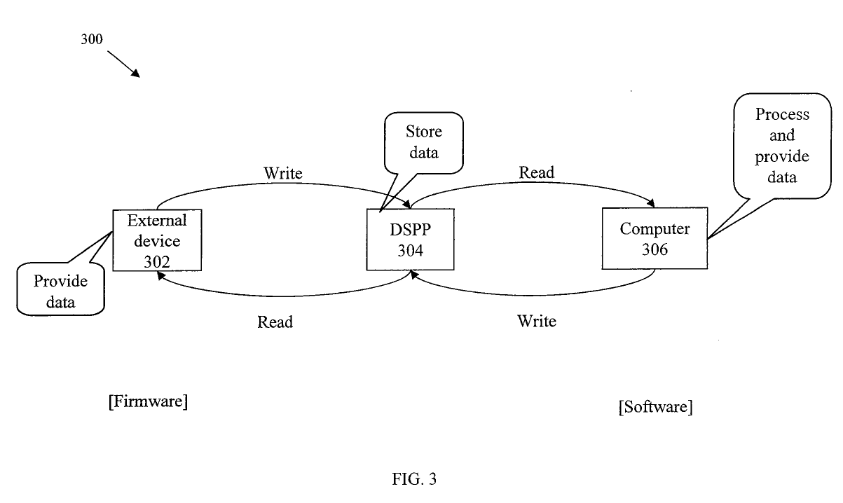

FIG. 3 is a diagram (300) illustrating an embodiment of a functional structure of the system (100) in FIG. 1. As shown in FIG. 3, a DSPP module (304) may exchange data with an external device (302) and a personal computer (306). FIG. 3 only illustrates one external device and one computer for illustration and description convenience. There may also be multiple external devices and multiple computers in the system (100).

Firmware may vary for different external devices. The external device (302) needs to have firmware that allows the external device (302) to provide data, and transfer data to and from the DSPP module (304). Functions of the firmware may allow the external device (302) to provide health related data—e.g., a blood pressure may need to provide blood pressure measurement, or a body weight scale may read body weight of a user, etc., and save the health related data in the DSPP module (304) in a format accessible to the computer (306) and other external devices in the system (100). When data on the external device (302) is available, and the DSPP module (304) is connected with the external device (302), the data may be stored into the DSPP module (304), automatically or manually.

Firmware on the external device (302) may also allow the external device (302) to read health related information from the DSPP module (304) when connected. For instance, a configuration file for the external device (302) is stored on the DSPP module (304), which defines the format of the health related data to be provided by the external device (304). The firmware allows the external device (304) to read in the configuration file and perform the configuration accordingly. Then the external device (302) may provide and save the health related data to the DSPP module (304) in the format described in the configuration file. When a fitness training program or a treatment program is available on the DSPP module (304), the external device (304) may read in the training or treatment program, execute the program, and/or guide users, e.g., by prompting a message or making an alarm, to follow instructions according to the training or treatment program to complete the training or treatment.

Functions of software running on the computer (306) may be provided to allow users to manipulate the health related data stored in the DSPP module (304), e.g., to read, view, edit, add, backup, analyze, output, etc., the health related data, and other related data. Functions of the software may allow users to backup data in the DSPP module (304) to the computer (306), or a secured database on an Internet or a Local Area network (LAN), and to download latest software and device firmware from the Internet or the LAN. The software may have different versions for various computer systems.

Functions of the firmware or the software may allow the external device (302) or the computer (306), respectively, to write data to the DSPP module (304) in a particular format. The format may be configurable, for example, by providing device configuration information to the external device (302). Data stored in the DSPP module (304) may be organized in different file structures based on different categorization requirements. For instance, the data may be stored based on time stamps for storing data, type of external devices that provide the data, or type of data stored.

Table 1 illustrates one embodiment for storing data obtained from different external devices or services in the DSPP module (304) in a specific format. In this embodiment illustrated, a main data folder, i.e., [Health_Manager_Carl_Lee], may be created to contain all the health related data, and some or all other related data, and subfolders may be created to contain data corresponding to different external devices or services. Each file in the main data folder may be a text file, an image file, or may be in any other applicable format.

TABLE 1

```
Main data folder:
[Health_Manager_Carl_Lee]
    Personal_profile.txt
    Alarm_settings.txt
    [Notes]
        yyyy-mm-dd_hh-mm-ss.txt
        yyyy-mm-dd_hh-mm-ss.doc
        yyyy-mm-dd_hh-mm-ss.pdf
        yyyy-mm-dd_hh-mm-ss.JPG
        yyyy-mm-dd_hh-mm-ss.MP3
        yyyy-mm-dd_hh-mm-ss.MPG
    [BP subfolder]
        Blood pressure data
        Device configuration
    [BW subfolder]
        Body weight data
        Device configuration
    [BIKE subfolder]
        Bike training programs and device configuration
        Activities records
    [TREADMILL subfolder]
        Treadmill training programs and device configuration
        Activities records
    [HOME_MON subfolder]
        Control programs and device configuration
        Home environment data
    [Rehabilitation subfolder]
        Diet program
        Treatment program
        Other program or schedule
    [Other subfolder]
        Control programs and device configuration
        Data
[FIRMWARE folder]
    [BP subfolder]
        BP firmware
        BP firmware configuration
    [BW subfolder]
        BW firmware
        BW firmware configuration
    [BIKE subfolder]
        BIKE firmware
        BIKE firmware configuration
    [TREADMILL subfolder]
        TREADMILL firmware
        TREADMILL firmware configuration
    [HOME_MON subfolder]
        HOME_MON firmware
        HOME_MON firmware configuration
    [Rehabilitation subfolder]
        Rehabilitation firmware
        Rehabilitation firmware configuration
    [Other subfolder]
        Device firmware
        Device firmware configuration
[SOFTWARE folder]
    Software
    Software configuration
========================
[other document folders]
    Other document files
```

The Personal_profile.txt file in Table 1 is an example for storing personal information about a user. As shown in Table 2, the personal information may include data such as name, gender, height and weight of the user, etc., and content and format of the personal information may vary.

TABLE 2

| | |
|---|---|
| Name: | Family-name First_name |
| Gender: | Male or Female |
| Birthday: | yyyy-mm-dd |
| Height: | cm |
| Weight: | Kg |
| ID: | ID# |
| Updated_on: | yyyy-mm-dd |

This personal information may be input from the computer (306) or the external device (304), and then saved as a file in the DSPP module (304). This personal profile file may be used as a source of personal information for other external devices or services. For example, before starting to exercise on a treadmill, a user may be asked to input certain personal information, such as age, weight, height, and gender etc, for calculating exercise efforts. If the user has a USB flash drive with him as the DSPP module (304), with personal information stored in the USB flash drive, and if the treadmill has an interface to connect to the USB flash drive, the user may ignore the inquiry, and just insert the USB flash drive to the treadmill. The personal information stored in the USB flash drive may be automatically read into the treadmill, providing a convenient way to input the personal information into the treadmill, and accurate personal information for measurement and calculation by the treadmill.

The software or firmware running on the computer (306) or the external device (302), respectively, may provide a function to setup alarms to remind a user for certain activities, such as measuring blood pressure, taking medications, or doing exercises, from the computer (306) or the external device (302). The alarm settings may be saved to a file under the main data folder, e.g. the Alarm_settings.txt file in Table. 1, or saved in the external device (302) if applicable or in the computer (306). The alarm may be made by the computer (306) when the DSPP module (304) is connected with the computer (306); or be made by the external device (302), if applicable, when the external device (302) is connected with the DSPP module (304). The external device (302) may read the alarm settings saved in the DSPP module (304), and make the alarm go off when a target time is reached. The alarm may go off when the external device (302) has an audio output. If the external device (302) is a device that has a display screen, e.g., a blood pressure meter, the external device (302) may also be set up to display purpose of an alarm when the alarm goes off.

The software or firmware running on the computer (306) or the external device (302) may also provide functions that allow a user to write notes and store the notes in the DSPP module (304), e.g., the files under subfolder Notes in Table 1. A note may be used to record information that is related to the use of the external device (302), and consequently, health related information provided by the external device (302). A note may include information that may help understand background of using the external device (302) and health conditions of a user of the external device (302), and help use the health related data provided by the external device (302). For example, a note may record reasons why a health related parameter is measured; or a note may record descriptions concerning the use of the external device (302), e.g., descriptions of professional observations, or feelings of a user of the external device (302), etc. A note may further record professional advices and/or opinions, suggested plans, e.g., treatment or prescriptions, or other supplemental information regarding the use of the external device (302). A note may be a text reminder like “start taking blood pressure reducing medications”, which may be saved as a text file, such as the yyyy-mm-dd_hh-mm-ss.txt file in Table 1, a Word Excel, Microsoft Excel, or pdf file, or a voice or video clip.

Notes may be useful when data stored in the DSPP module (304) is accessible via an Internet or a LAN. For example, a user may upload the health related data to a database on the Internet or the LAN, and give an access permission to a doctor. A doctor may then view the data remotely, and write and submit a note, such as a prescription, to the database on the Internet or LAN. The user may then download the note into the DSPP module (304). Thus the prescription will be accessible to the user remotely right after the doctor enters the note.

In another example, a fitness trainer may view via the Internet a user's exercise records, write notes for the user, give suggestions for performing exercises or adjust corresponding training programs, that may be multiple programs for multiple exercise apparatus. The user may read the notes, download the updated training programs to the DSPP module (304), bring the DSPP module (304) to a gym, and perform exercises according to the suggestions and updated training programs. The fitness trainer may further set up exercise targets, e.g., a target value of energy consumption, for the training by way of writing notes, and request the user to reach a target in a certain time period. Firmware on a fitness apparatus may provide functions to keep tracking the exercise activities with respect to the target set, and remind (may be by text, chart, or voice) the user how far away it is from the target.

Under the main data folder [Health_Manager_Carl_Lee in Table 1, multiple subfolders are created corresponding to various external devices, each subfolder storing health related data and other related data of a corresponding external device. For example, as shown in Table 1, a BP subfolder is created storing blood pressure records, which may include systolic pressure, diastolic pressure, heart rate, optional room temperature and humidity, etc.; a BW subfolder for storing body weight records; a BIKE subfolder or a TREADMILL subfolder for storing fitness activity records, such as speed, incline, loading/resistance, heart rate, energy consumption, etc., corresponding to a bike or a treadmill; and a HOME_MON subfolder for storing home temperature/humidity control parameters as well as temperature/humidity readings.

A subfolder under the main data folder [Health_Manager_Carl_Lee may also store health related programs for a corresponding external device if applicable. For instance, the BIKE subfolder may store bike training programs/profiles, such as a target speed, resistance, and/or target time of exercises; a Rehabilitation subfolder may include diet programs, treatment programs or other programs, etc.

Device configuration information for configuring the external device (302) may be stored in the DSPP module (304). One type of configuration information may be information that individualizes specific configurations of the external device (302), with respect to a specific user, such as the Device configuration file under each subfolder in the main data folder [Health_Manager_Carl_Lee]. The individualized configurations may allow a user to have personalized settings on the external device (302) he/she is using. The individualized configurations may define whether certain measurement is to be automatically performed or stored, such as the room temperature, etc. When connected with the DSPP module (304), firmware running on the external device (302) may allow the external device to automatically read in the individualized configurations, and perform the configuration accordingly.

A main folder, [FIRMWARE folder], as shown in Table 1, may be created, under which multiple subfolders are created storing the latest firmware for corresponding external devices. For instance, the BP subfolder and the BW subfolder under the [FIRMWARE folder contain BP firmware and BW firmware, respectively, for upgrading a blood pressure or a body weight scale. Thus firmware on an external device, e.g., (302), may get upgraded when the external device is connected with the DSPP module (304).

A subfolder of a corresponding external device under the [Firmware folder in Table 1 may also contain device configuration information for configuring generally the corresponding external device, such as the firmware configuration under the BP subfolder. The firmware configuration under the BP subfolder may include definitions of the format for saving the blood pressure data and/or other related data into the DSPP module (304).

The software for the computer (306) may be stored in the DSPP module (304) under a [SOFTWARE folder], as shown in Table 1. This provides more flexibility when users go to some places where no such software is available, and want to manipulate health related data collected. Using different subfolders to store data obtained from different type of external devices, or to store other related data for the different type of external devices, allows the system (100) to flexibly add more and new external devices to the system portfolio. For example, by upgrading the software, the system (100) may easily add a new subfolder in the DSPP module (304) for storing diagnosis, treatment or the like information obtained from an external medical institution, such as a hospital.

Table 3 illustrates an embodiment of a TREADMILL subfolder under the main data folder [Health_Manager_Carl_Lee in Table 1, where a PROFILE.txt file may be used to include information about the treadmill, such as a treadmill training program and/or treadmill configuration information, and sub-subfolders [2006 and [2007 may include all exercise records for year 2006 and 2007, respectively. The 1020.csv and 1022.csv files contain treadmill data recorded for exercise performed on Oct. 20, 2006 and Oct. 22, 2006, respectively.

TABLE 3

```
[TREADMILL]
  PROFILE.txt
    1020.csv
  1022.csv
  ```

The software running on the computer (306) and firmware on the external device (302) may be upgraded, automatically or manually, and locally or remotely. The software running on the computer (306) may provide functions to check via Internet whether the latest software is running on the computer (306) when the Internet is available. If not, the latest software may be downloaded and installed automatically or manually operated. When out of date software detects an unrecognized subfolder created by an external device under the main data folder, a user may be asked to download and install the most upgraded software from the Internet or from a CD.

The version of firmware running on an external device may also be tracked to determine whether the latest firmware is running on the external device. If not, the external device may give a reminder for upgrading the firmware. An owner, an administrator of an external device, or people authorized may have right, that may be in different levels, to upgrade firmware of the external device, and authentication for upgrading may be applied. For instance, an owner of a blood pressure measurement device may upgrade firmware of his/her blood pressure measurement device when needed, and the owner may need enter user ID and password before starting the upgrading process. In an alternative example, an administrator and a manager of a gym may both have right to upgrade firmware, but with respect to different group of fitness apparatuses in the gym. The latest firmware may be stored to a DSPP module, and installed on the extern device when the DSPP module with the latest firmware is connected with the external device.

The main data folder and subfolders therein may be created when a user first uses the system (100). For example, a user runs the software on a computer, and connects a new and empty USB flash drive with the computer. The software may ask the user whether a new main data folder is to be created in the USB flash drive. The user may further be asked to input personal information which may be stored under the main data folder. When the user connects the USB flash drive to an external device, such as a treadmill, a subfolder for the treadmill may be automatically created under the main data folder in the USB flash drive, and treadmill data will be saved under this subfolder.

However, if the user directly connects a new and empty USB flash drive to the treadmill, a main data folder and a treadmill subfolder may be automatically created on the USB flash drive, and treadmill data will be saved under this subfolder. But no personal information may be input and saved at this time. The user may input the personal profile later using a computer.

Each time to collect and store the health related data from the external device (302), the DSPP module (304) should be connected with the external device (302) that will provide the health related data. Collection and storage processes may vary for different external devices. For example, in case of a blood pressure meter, a user may first connect a USB flash drive, as an example of the DSPP module (304), with the blood pressure meter by inserting the USB flash drive into a USB connector on the blood pressure meter, and start the measurement. Data resulting from the measurement, such as systolic pressure, diastolic pressure, heart rate, etc, may be packed into one file and stored in the USB flash drive. In the case of a treadmill as another example, a user may first connect a USB flash drive with the treadmill, and then begin the exercise. Personal information available in the USB flash drive may be read in by the treadmill for exercise effort calculation, and exercise programs available in the USB flash drive may also be read in by the treadmill for performing exercises. The treadmill may record exercise effort data and store the data into the USB flash drive, periodically during the exercise, or after the exercise. The treadmill may further store exercise programs into the USB flash drive as records.

Security may be applied for accessing data involved in the system (100) with respect to each user. The data provided or stored may be encrypted, and a user may need to be authenticated before he/she accesses the data, e.g. a user may be asked to input a user ID and a password if he/she wants to access the data. The user may be provided with a default user ID and password when the user first uses the system (100), and may change the user ID and password any time later.

Different users may be assigned different user IDs and passwords, and different level of accessibility for accessing the health related data or other related data of the system (100). The level of accessibility may depend on role of each user played in the system (100). For example, a patient uses a DSPP module (304) integrating and managing his/her health related information. The patient's doctor, fitness trainer may use different user IDs and passwords to open different portion of the patient's health related data. The authentication may be applied and implemented in different manners and technologies.

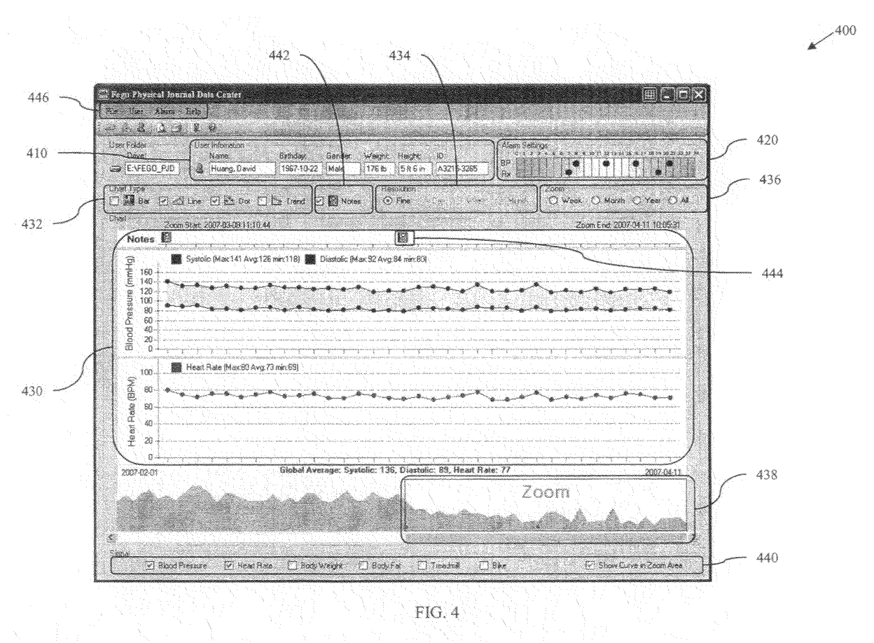

A user interface may be provided to enable a user to manipulate the health related data and other related data on the computer (306). FIG. 4 illustrates an embodiment of a main page (400) for the user interface. It is to be understood that the main page (400) in FIG. 3 is only an embodiment used to describe a possible user interface for the system (100).

The main page (400) may be divided into multiple sections. Section (410) displays personal information of the user. Section (420) indicates alarm settings during certain period of time, such as during the current month. Alarm settings, such as number of alarms, time and category of alarms, etc, may be seen from this section. For example, as show in the section (420), there are four alarms set up for blood pressure measurement at different time. The alarm may be set up using the menu “Alarm” on the main page (400), and the section (420) will be updated after the alarm setup is done.

Sections (432)-(442) may be used to control graphical display of various data in section (430). Data may be displayed using different types of graphs, such as a line chart, or a dot chart, etc. In this embodiment, the icon “line” in section (432) is checked and therefore, the blood pressure and heart rate in section (430) are displayed by line charts. Scale and range for displaying the graphs may be controlled by section (434) and (436), respectively. Section (438) may display enlarged part of the graphs selected. The main page (400) may also be set up to display graphs for other data in section (430) using section (440), where, in this embodiment, blood pressure and heart rate are checked, indicating graphs regarding blood pressure and heart rate are displayed in section (430).

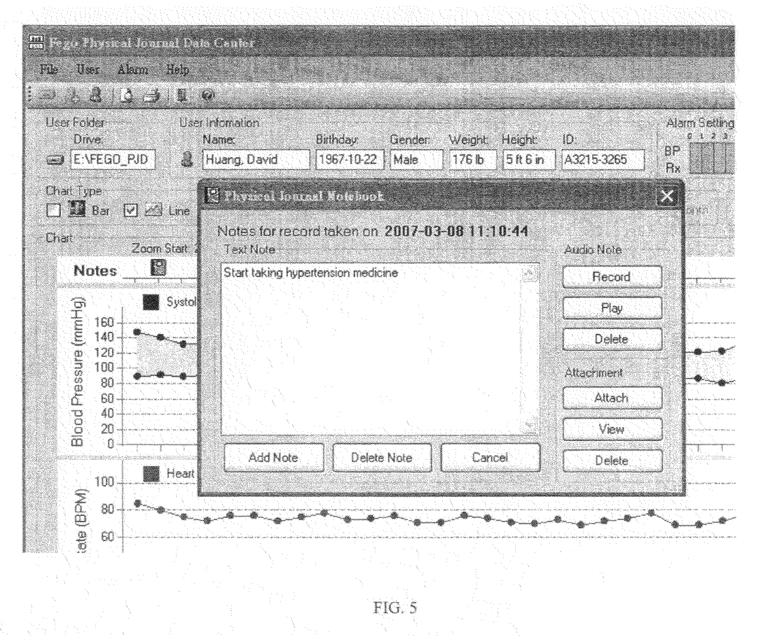

Notes may also be displayed on the screen. For example, as shown in the main page (400), the checked icon “Notes” (442) indicates that data currently displayed will be marked up if at least one note has been provided. Therefore, icon (444) displayed on the graph of blood pressure in section (430) indicates that a note is provided with respect to the blood pressure data. FIG. 5 illustrates an example of a note displayed on the screen.

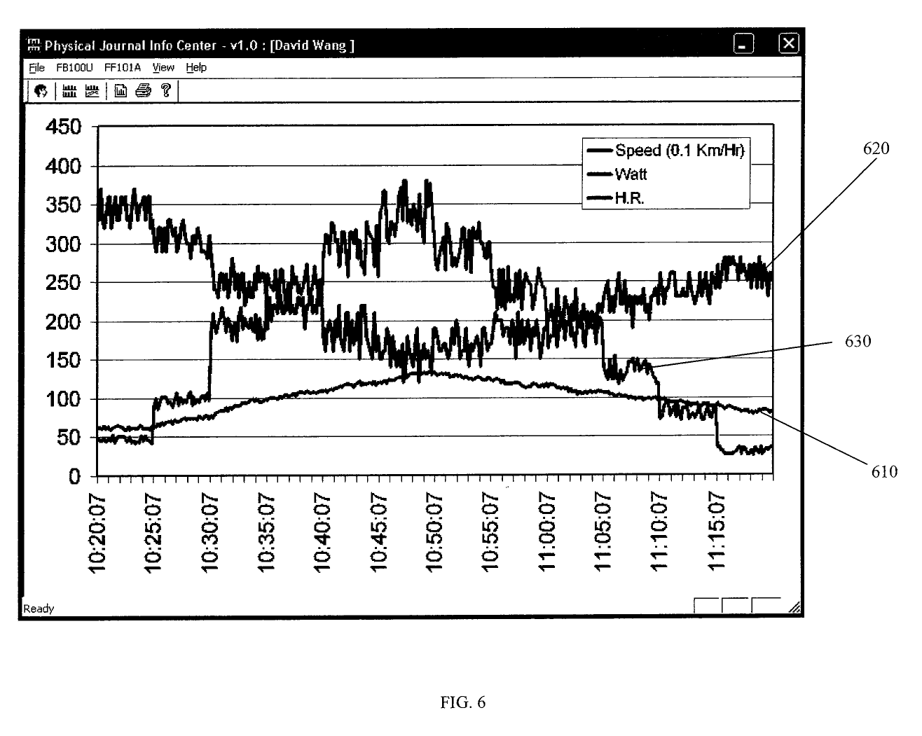

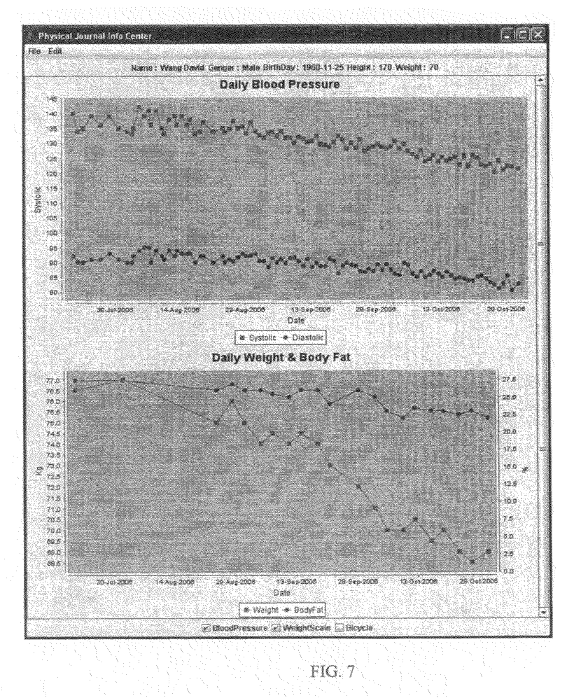

By utilizing the main menu (446) on the main page (400), different health related information may be displayed on the screen. The various health related information may be displayed on the computer screen in different ways, such as in graphs, texts or combination of both graphs and texts. The health related information may also be displayed in audios or videos. Graphs may vary from a simple line chart, bar chart, to a complicated mesh graph. A graph may include curves or trends of a certain time period in time-domain. For example, as illustrated in FIG. 6, multiple data curves are combined to show heart rate readings, i.e., curve (610), compared with exercise speed, i.e., curve (620), and Watt (or Calories), i.e., curve (630). FIG. 7 includes two graphs comparatively illustrating relationship between daily blood pressure, weight and body fat. These graphs may be used to help users understand impact of exercises on health, and influence of one physiological parameter on the others.

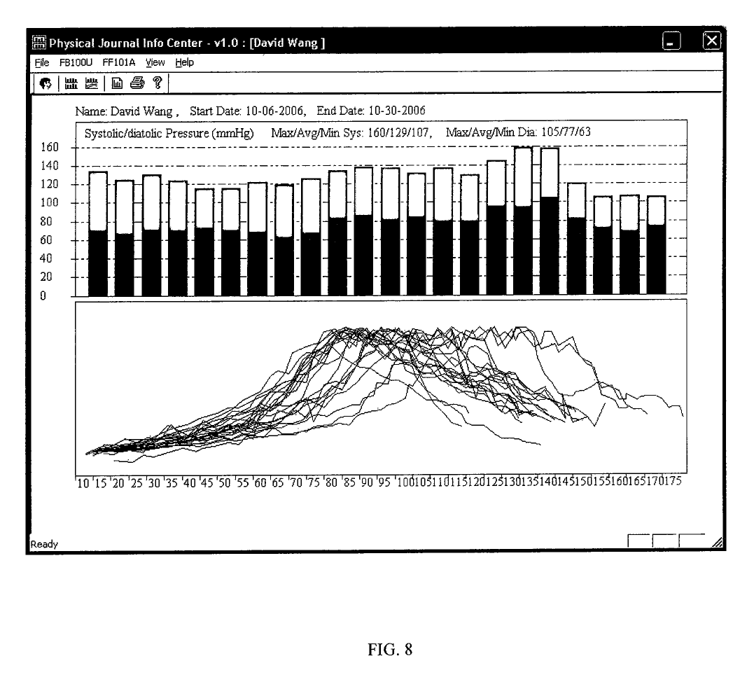

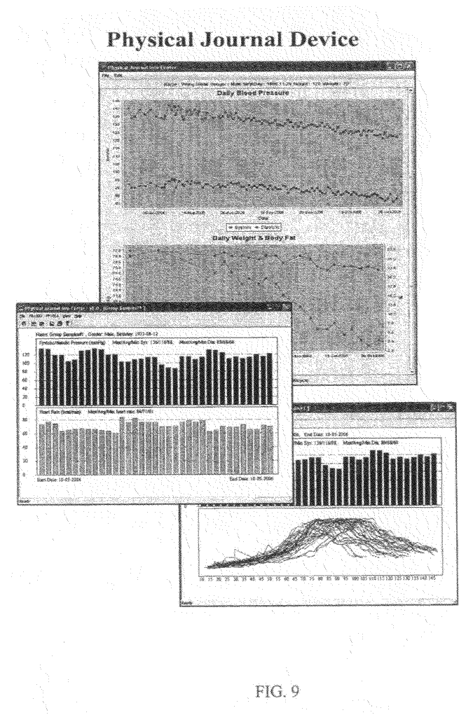

In FIG. 8, different types of graphs, e.g., a bar chart and a line chart, are used to illustrate trend of blood pressure. The system (100) may also allow multiple windows displayed on the screen, as illustrated in FIG. 9. Users may take advantage of this feature to get a more comprehensive understanding of the health related information.

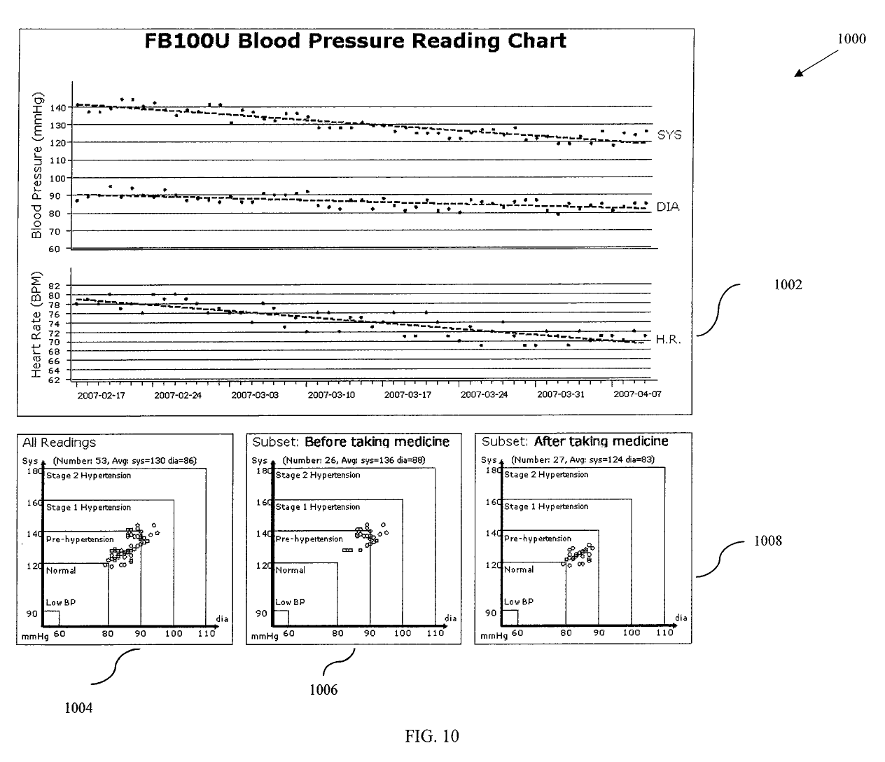

Furthermore, the graphs may also provide statistic analysis results to compare data within a certain time period with other time period. For instance, a line chart shows comparison of blood pressure before and after taking a certain blood pressure reduction medication. The data may also be displayed in groups, such as before and after noon time. This may help user understand variation of health parameters measured with respect to time or measurement conditions. FIG. 10 illustrates an embodiment of a statistic analysis display of blood pressure data, which indicates results of blood pressure control by taking certain medications. Graph (1002) illustrates systolic, diastolic pressure values and heart rates during a period from Feb. 17, 2007 to Apr. 7, 2007. Graphs (1004), (1006) and (1008) illustrate the systolic pressure and diastolic pressure distribution during the same period of time, wherein graph (1004) shows the over all blood pressure data distribution during this period of time, and (1006) and (1008) show blood pressure data distribution before and after taking the medications, respectively. Comparing graph (1006) and (1008), a user may clearly find out whether his/her blood pressure is improving by taking the medication, e.g., within a normal distribution range or not.

Functions of the software may be provided on the computer (306) to analyze the data stored in the DSPP module (304). The analysis may correlate various health related data, and give a general comparison, suggestions or alerts. Users may view analysis results in graphs and/or texts on the screen, save the analysis results in the computer (306), the DSPP module (304) or a database server, and output the analysis results, e.g., using a printer. The analysis results may be very useful references to users or other health related professionals.

Moreover, functions of the software on the computer (306) may further allow the system (100) to backup the data stored in the DSPP module (304) to hard-drive on the computer (306), and/or a local or remote database server. Thus a user may view the data when the DSPP module (304) is not available, or anywhere in the world when Internet access is available. The software may allow a users to send emails to other people indicating that updated data has been uploaded to the remote database server, or send emails to other people with the updated data attached.

In addition, functions of the software may allow users to edit fitness training programs or medical treatment programs according to the health related data and analysis results via the computer (306), and store the fitness training or the treatment programs in the DSPP module (304). An external device, such as a fitness apparatus, or a healthcare device may read in the fitness training or the treatment programs from the DSPP module (304) when connected, and provide correspondent services according to the training programs or the treatment plans.

A fitness training program may include two parts. One part is for configuring a fitness apparatus to provide specific exercise instructions, e.g., exercise instructions for a treadmill may be: 3 miles/hour in speed and 0 degree in incline for the 1st 5 minutes, 5 miles/hour and 10 degrees incline for the 2nd 5 minutes, 8 miles/hour and 15 degrees incline for the next 20 minutes, and reducing to 3 miles/hour and 0 degree incline for the last 5 minutes. When the fitness apparatus is activated, the fitness apparatus may execute the exercise instructions and provide corresponding exercises to a user.

The other part of a fitness training program may include guiding instructions that may guide users in a specific means, e.g., by prompting messages or making alarms, to follow the exercise instructions to complete the training program. The prompted message may be texts on a display of an external device, signal of light, voice, video, music, vibration, temperature change, or electric stimulation, etc.

A treatment program may also include two part: one part includes treatment instructions that a treatment device may execute and provide a specific treatment; and the other part includes guiding instructions that may provide guides in a specific means, e.g., by prompting message which may be the same as that for fitness training programs, or making alarms, to help user follow the treatment instructions to complete the treatment.

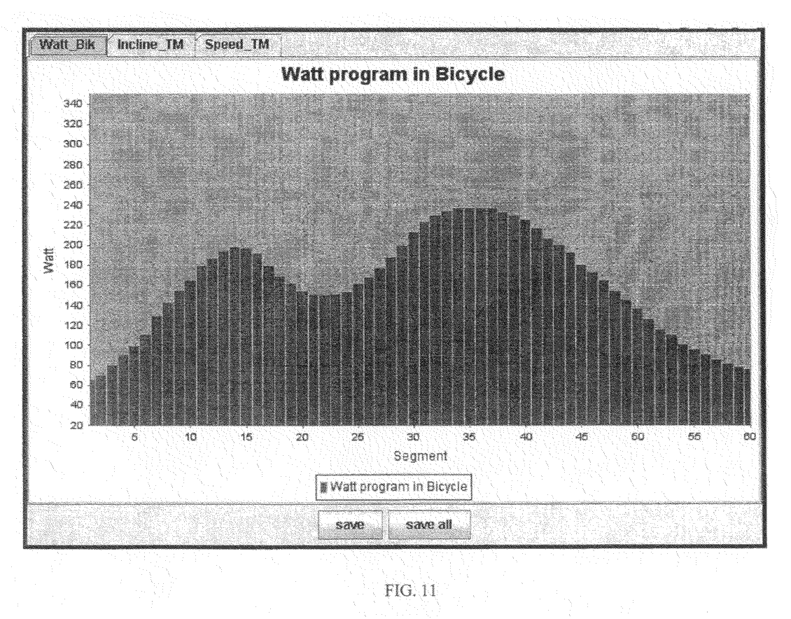

A user-friendly interface may be provided for a user to edit a training program or a treatment program. FIG. 11 illustrates an embodiment of an interface to edit a training program of a fitness apparatus, e.g., a bike, where a user may edit calories to be consumed, incline degree and speed.

In the system (100) described in FIG. 1, one DSPP module (110) is provided per user. Thus a user may carry the DSPP module (110), connect the DSPP module (110) with an external device when data transfer is desired between the external device and the DSPP module (110), and store all health related information about the user in the DSPP module (110). The health related data transferred from the external device to the DSPP module (110) may be automatically stored under a main data folder already created by the user.

Moreover, the DSPP module (110) may be shared by multiple users as long as there is enough space on the DSPP module (110). Firmware and software may be extended to provide functions to support multiple users. For example, two users, a husband and his wife, are using one USB flash drive for storing their health related information. Each user may have one independent main data folder created on the USB flash drive, each main data folder having a different name. In this case, each user may be assigned a unique key or an ID, which may be saved in the USB flash drive and used for distinguishing the two users. When connected with the USB flash drive, an external device may ask each user to provide the assigned key to determine which main data folder the data may be transferred to.

The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for integrating and managing health related information, comprising:
at least one portable data storage device, adapted to store data comprising health related information;
at least one external device, adapted to provide health related information, and to exchange health related information with the at least one portable data storage device, when the at least one portable data storage device is removably connected with the at least one external devices; and
at least one component, adapted to manipulate health related information stored in the at least one data storage device, and to exchange health related information with the at least one portable data storage device, when the at least one portable data storage device is removably connected with the at least one component;
wherein the health related information in the at least one portable data storage device is stored in a specific format, and is accessible by any external device or component in the system.

2. The system of claim 1, wherein the at least one portable data storage device is adapted to manipulate health related information.

3. The system of claim 1, wherein the at least one portable data storage device comprises a non-volatile memory product.

4. The system of claim 3, wherein the non-volatile memory product comprises a flash drive, a memory card, a memory Integrated Circuit (IC) card, or a Radio Frequency Identification (RFID) tag,.

5. The system of claim 1, wherein the at least one portable data storage device comprises a Data Storage and Program Provision (DSPP) module.

6. The system of claim 1, wherein health related information is stored in the at least one portable data storage device in a text file, a Microsoft Office Word file, a Microsoft Excel file, or a pdf file.

7. The system of claim 1, wherein health related information is stored in the at least one portable data storage device according to categorization by external device type, type of data stored, or time for storing data.

8. The system of claim 1, wherein the format is configurable.

9. The system of claim 1, wherein the at least one external device or the at least one component comprises an interface for communicating with the at least one portable data storage device.

10. The system of claim 9, wherein the interface provides a physical or wireless connection.

11. The system of claim 1, wherein the at least one external device comprises a healthcare device, a medical treatment device, a medical diagnosis device, a fitness apparatus, a home environment control or monitoring device, or a computer.

12. The system of claim 1, wherein the at least one component comprises a computer or a Personal Digital Assistant (PDA).

13. The system of claim 1, wherein the at least one component provides or stores health related information.

14. The system of claim 1, wherein the health related information comprises health related records, health related programs, or system related information.

15. The system of claim 1, wherein the at least one external device is adapted to read configuration information from the at least one portable data storage device for configuring the format of the health related information that the at least one external service provides to the at least one portable data storage device.

16. The system of claim 1, wherein at least one external device is adapted to read a fitness training program from the at least one portable data storage device, and provide exercise instructions or guiding instructions according to the fitness training program.

17. The system of claim 16, wherein the fitness training program is provided and stored in the at least one portable data storage device by the at least one component.

18. The system of claim 16, wherein the guiding instructions are in audio, visual, mechanical format, or any combination thereof.

19. The system of claim 1, wherein the at least one external device is adapted to read a medical treatment program from the at least one portable data storage device, and provide treatment instructions or guiding instructions according to the medical treatment program.

20. The system of claim 19, wherein the medical treatment program is provided and stored in the at least one portable data storage device by the at least one component.

21. The system of claim 1, wherein the at least one component is adapted to provide a user interface for manipulating the health related information.

22. The system of claim 1, wherein the at least one component is adapted to display the health related information on a display screen, the health related information being displayed in a format of graphs, texts, audios, videos, or any combination thereof.

23. The system of claim 1, wherein the at least one external device or the at least one component is adapted to provide a note or an alarm for corresponding health related information.

24. The system of claim 23, wherein the note is provided in a format of texts, images, audios, videos, or any combination thereof.

25. The system of claim 1, wherein the at least one component is adapted to connect with an Internet or a Local Area Network (LAN).

26. The system of claim 1, wherein user authentication is applied for access of the health related information in the system.

27. The system of claim 1, wherein the health related information in the system is encrypted.

28. The system of claim 1, wherein the at least one component is adapted to analyze the health related information, the analysis results being stored in the at least one portable data storage device, the at least one component or a database server on an Internet or a Local Area Network (LAN).

29. The system of claim 1, wherein one portable data storage device is used by one user or multiple users to integrate and manage health related information of the one user or the multiple users.

30. The system of claim 29, wherein the at least one external device or the at least one component is adapted to distinguish each of the multiple users in exchanging data with one portable data storage device, when the multiple users are using the one portable data storage device.

31. The system of claim 1, wherein the at least one portable data storage device is adapted to provide at least one health related function.

32. A system for integrating and managing health related information, comprising:
at least one portable data storage device, adapted to store data comprising health related information and to manipulate the health related information stored;
a least one external device, adapted to provide health related information, and exchange health related information with the at least one portable data storage device when the at least one portable data storage device is removably connected with the at least one external device;
wherein the health related information in the at least one portable data storage device is stored in a specific format, and is accessible by any external device in the system.

33. The system of claim 32, wherein the at least one portable data storage device comprises a non-volatile memory product.

34. The system of claim 32, wherein the at least one portable data storage device is removably connected with the at least one external device wirelessly or physically.

35. The system of claim 32, wherein the at least one external device comprises a healthcare device, a medical treatment device, a medical diagnosis device, a fitness apparatus, a home environment control or monitoring device, or a computer.

36. The system of claim 32, wherein the health related information comprises health related records, health related programs or system related information.

37. The system of claim 32, wherein the format is configurable.

38. The system of claim 32, wherein the at least one portable data storage device is adapted to provide at least one health related function.

39. A system for providing, collecting, storing, exchanging and manipulating health related information, comprising:
at least one portable data storage device, adapted to collect and store data comprising health related information;
at least one external device, adapted to provide health related information, and adapted to exchange health related information with the at least one portable data storage device, when the at least one portable data storage device is removably connected with the at least one external device; and
at least one component adapted to manipulate the health related information, and adapted to exchange health related information with the at least one portable data storage device, when the at least one portable data storage device is removably connected with the at least one component;
wherein the health related information collected in the at least one portable data storage device is stored in a specific format, and is accessible by any external device or component in the system.

40. The system of claim 39, wherein the at least one portable data storage device comprises a non-volatile memory product.

41. The system of claim 39, wherein the at least one portable data storage device is removably connected with the at least one external device or the at least one component wirelessly or physically.

42. The system of claim 39, wherein the at least one external device comprises a healthcare device, a medical treatment device, a medical diagnosis device, a fitness apparatus, a home environment control or monitoring device, or a computer.

43. The system of claim 39, wherein the health related information comprises health related records, health related programs or system related information.

44. The system of claim 39, wherein the at least one component is adapted to have a user interface for manipulating the health related information.

45. The system of claim 39, wherein the at least one component comprises a computer or a Personal Digital Assistant (PDA).

46. The system of claim 39, wherein the format is configurable.

47. The system of claim 39, wherein the at least one portable data storage device is adapted to provide at least one health related function.
